(19) United States
(12) Patent Application Publication
(10) Pub. No.: US 2023/0402728 A1
(43) Pub. Date: Dec. 14, 2023

(54) System and Method of Signal Transmission Through a Battery Cell for in Cell Sensing

(71) Applicant: Sensata Technologies, Inc., Attleboro, MA (US)

(72) Inventors: Jonathan M. Rigelsford, Oughtibridge, Sheffield, South Yorkshire (GB); Nicolas R. Henriet, Arcon (GB)

(21) Appl. No.: 18/044,974

(22) PCT Filed: Sep. 16, 2021
(86) PCT No.: PCT/US21/50710

§ 371 Date: Mar. 10, 2023

Related U.S. Application Data
(60) Provisional application No. 63/082,690, filed on Sep. 24, 2020.

(51) Int. Cl. H01M 50/569; H01M 10/48; H01M 10/42; H01M 10/44; H02J 7/00

(52) U.S. Cl. CPC H01M 50/569; H01M 10/486; H01M 10/425; H01M 10/443; H02J 7/007188; H02J 7/00712; H01M 2010/4278; H01M 2010/4271

(57) ABSTRACT

A system and method of in cell sensing is provided. The method may include measuring sensing data from a sensor assembly hermetically sealed within a battery cell. The sensor assembly may include a sensing element, a processor and a radio. The method may further include sending and receiving the sensing data, via the sensor assembly. The sensing data may include at least one of temperature, pressure, voltage and shock of the battery cell.

### RELATED APPLICATIONS

The subject application claims the benefit of U.S. Provisional Application having Ser. No. 63/082,690, filed 24 Sep. 2020. The entire content of which is herein incorporated by reference.

### BACKGROUND

Lithium-ion cells are the primary choice for portable energy storage devices because of their high energy densities. During the charge and discharge cycle internal pressures are developed and are proportional to the cell capacity. The internal pressure decreases rapidly during the discharge cycle. The pressure induced during the second charge process is lower than the first cycle pressure and the peak pressure in the subsequent cycles will be smaller. As a safety feature, such cells are fitted with a pressure release valve, designed to ensure that the cell does not explode. The ability to measure the internal pressure of a cell provides useful information for the design of electrode coatings, packs and casings.

### SUMMARY OF THE DISCLOSURE

As will be discussed in greater detail below, embodiments of the present disclosure include a system and method of in cell sensing where sensing data may be measured, sent and received from within a battery cell. The method may include measuring sensing data from a sensor assembly hermetically sealed within a battery cell. The sensor assembly may include a sensing element, a processor and a radio. The method may further include sending and receiving the sensing data, via the sensor assembly. The sensing data may include at least one of temperature, pressure, voltage and shock of the battery cell.

One or more of the following features may be included. In some embodiments, the method may further include providing communication between a battery pack of wireless enabled battery cells and a central controller. The method may also include providing communication between a module of wireless enabled battery cells and a local controller. The method may further include relaying, via the local controllers, the sensing data back to a master controller. The master controller may be in communication with a BMS (Battery Management System). The communication between the local and master controllers may include wired and/or wireless communication. In some embodiments the method may also include adjusting the charge and discharge of the battery cell based upon, at least in part, the sensing data relayed to the master controller. The sensor assembly may include an antenna connected to a case of the battery cell, wherein the case of the battery cell may be configured to operate as a part of the radiating element of the antenna. The sensor assembly may further include an antenna connected to at least one of an anode and a cathode, wherein the at least one of the anode and the cathode may be configured to operate as a part of the radiating element of the antenna. In some embodiments, the sensor assembly may further include an antenna, wherein the radio may be configured to operate at one or more frequency bands. The method may further include multiplexing one or more radio signals, via the sensor assembly, using at least one of a time division multiplexing and/or a frequency division multiplexing. The battery cell may be at least one of a metal cased prismatic battery cell, a prismatic can battery cell, a prismatic pouch battery cell, and a cylindrical can battery cell. The battery cell may include at least one of a rigid casing and a flexible casing. In some embodiments, the sensor assembly may be in electrical communication with the battery cell.

In one or more embodiments of the present disclose a sensor assembly is included. The sensor assembly may include a sensing element, a processor and a radio. The sensing element may be configured to measure sensing data within a battery cell. The sensing data may include at least one of temperature, pressure, voltage and shock. The processor may be in communication with the sensing element. The radio may be in communication with the processor and may be configured to send and receive sensing data. The sensing element, the processor, and the radio may be hermetically sealed within a battery cell.

One or more of the following features may be included. In some embodiments, the radio may be configured to provide the sensing data to a local controller. The local controller may be configured to relay the sensing data to a master controller in communication with a BMS (Battery Management System). In some embodiments, the sensor assembly may further include an antenna in communication with the radio. The antenna may be connected to a case of the battery cell, whereby the case of the battery cell may be configured to operate as a part of the radiating element of the antenna. In some embodiments, the sensor assembly may further include an antenna in communication with the radio. The antenna may be connected to at least one of an anode and a cathode, whereby the at least one of the anode and the cathode may be configured to operate as a part of the radiating element of the antenna. In some embodiments, the radio may be configured to operate at one or more frequency bands. The radio may be configured to output a multiplexed signal of one or more radio signals. The multiplexed signal may include at least one of a time division multiplexing and a frequency division multiplexing. In some embodiments, the processor and the radio may be in electrical communication with the battery cell.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

This summary is provided to introduce a selection of concepts that are further described below in the detailed description. This summary is not intended to identify essential features of the claimed subject matter, nor is it intended to be used as an aid in limiting the scope of the claimed subject matter.

### BRIEF DESCRIPTION OF THE DRAWINGS

Embodiments of the present disclosure are described with reference to the following figures.

FIG. 1 illustrates an embodiment of a battery pack consistent with embodiments of the present disclosure;

FIG. 2 illustrates a flowchart showing operations consistent with embodiments of the present disclosure;

FIG. 3 illustrates a diagram consistent with embodiments of the present disclosure;

FIG. 4 illustrates a diagram of a prismatic battery consistent with embodiments of the present disclosure;

FIG. 5 illustrates another diagram of a prismatic battery consistent with embodiments of the present disclosure;

FIG. 6 illustrates an embodiment of a battery pack consistent with embodiments of the present disclosure;

FIG. 7 illustrates a diagram showing a Received Signal Strength Indicator (RSSI) measured from within a cell to a receiver within an automotive battery pack; and

FIG. 8 illustrates an embodiment showing the decoupling of the power supply of the sensor from the RF signal using of ferrite beads consistent with embodiments of the present disclosure.

Like reference symbols in the various drawings may indicate like elements.

### DETAILED DESCRIPTION

The discussion below is directed to certain implementations. It is to be understood that the discussion below is only for the purpose of enabling a person with ordinary skill in the art to make and use any subject matter defined now or later by the patent “claims” found in any issued patent herein.

It is specifically intended that the claimed combinations of features not be limited to the implementations and illustrations contained herein, but include modified forms of those implementations including portions of the implementations and combinations of elements of different implementations as come within the scope of the following claims. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure. Nothing in this application is considered critical or essential to the claimed invention unless explicitly indicated as being “critical” or “essential.”

It will also be understood that, although the terms first, second, etc. may be used herein to describe various elements, these elements should not be limited by these terms. These terms are only used to distinguish one element from another. For example, a first object or step could be termed a second object or step, and, similarly, a second object or step could be termed a first object or step, without departing from the scope of the invention. The first object or step, and the second object or step, are both objects or steps, respectively, but they are not to be considered a same object or step.

As discussed above, lithium-ion cells are the primary choice for portable energy storage devices because of their high energy densities. During the charge and discharge cycle internal pressures are developed and are proportional to the cell capacity. Typical values show that the pressure exerted by electrodes due to electrolyte soaking alone is 0.15 MPa, and increases to a peak value of approximately 1 MPa at the end of charging. The internal pressure may decrease rapidly during the discharge cycle. The pressure induced during the second charge process is lower than the first cycle pressure and the peak pressure in the subsequent cycles may be smaller. As a safety feature, such cells may fitted with a pressure release valve, designed to ensure that the cell does not explode. The ability to measure the internal pressure, as well as other internal conditions, of a cell may provide useful information for the design of electrode coatings, packs and casings.

More importantly, the ability to measure and report internal cell pressure and temperature may be used to better improve the management of the cell and its state of health (SOH) to provide a longer useable battery life. Although embodiments of the present disclosure may not eliminate the requirement for a safety valve, the ability to measure the internal pressure of a cell may help protect the cell and prevent thermal runaway, as the battery management system (BMS) may stop charging or discharging if a cell is showing abnormal pressure and temperature characteristics. Embodiments included herein may also utilize other sensing data including, but not limited to, temperature, voltage and shock.

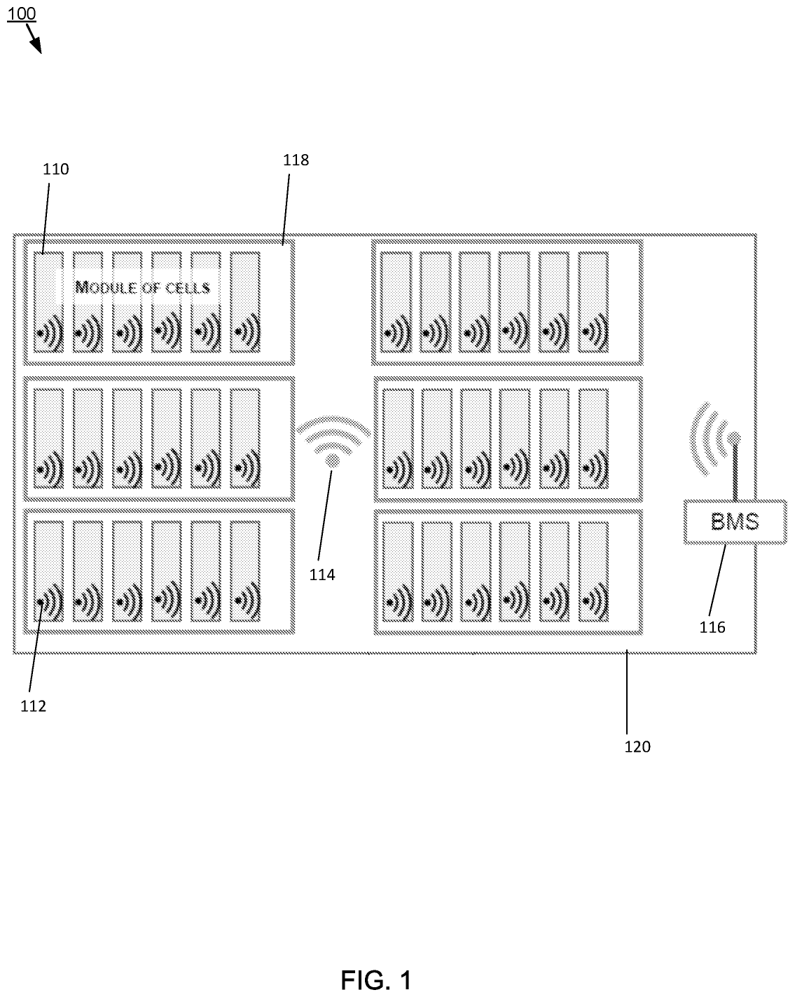

Referring now to FIGS. 1-7, embodiments of the present disclosure provide a system and method of in-cell sensing where sensing data may be measured, sent and received from within a battery cell. Embodiments included herein may enable sensing data such as temperature, pressure, voltage and shock, to be measured from within the cell without the need for wires passing through the hermetic seal of the cell.

In some embodiments, the ability to measure the internal pressure, as well as other internal conditions, of a cell provides useful information for the design of electrode coatings, packs and casings. More importantly, the ability to measure and report internal cell pressure and temperature can be used to better improve the management of the cell and its state of health (SOH) to provide a longer useable battery life.

Accordingly, a system and method to transmit the data using a wireless radio signal is proposed to achieve the goal of measuring sensing data from within the battery cell without altering or negatively impacting the hermetic seal of the cell. A typical battery cell casing, for example a prismatic battery cell casing, may not provide perfect shielding effectiveness to prevent transmission of radio signals from the inside to the outside, although a metallic casing may provide a considerable level of signal attenuation. Shielding effectiveness is a measure of how well a shield suppresses electromagnetic radiation, and is dominated by the physical properties of the metal. Waves with a dominant electrical field may be reflected by highly conductive metals (e.g., Cu, Ag, Au) while magnetically dominant waves may be absorbed/suppressed by ferromagnetic materials (e.g., Fe, Ni, Co), including steel and some grades of stainless steel. In some embodiments, the electrical insulation material around the cathode of the battery cell may also provide a path for the electromagnetic signal to “leak” from the battery cell. In other embodiments, the anode may also provide a path for the electromagnetic signal to “leak” from the battery cell.

In most traditional radio communications systems, the additional signal attenuation introduced by the shielding effectiveness of a metallic enclosure may make the system inoperable as the signal strength received at a distance outside of the enclosure would be below the minimum detectable by the radio (the receiver's sensitivity). In some embodiments, for advanced sensing applications within a cell, the maximum required operational range for a radio system may likely to be less than 2 meters, which corresponds to about the size of a large automotive battery pack. In a system operating at 433 MHz this may be less than 3 wavelengths, whereas the same distance for an equivalent operating at 2.4 GHz may be over 16 wavelengths. All things being equal, in a free-space propagation environment this equates to an additional 15 dB path loss.

Therefore, embodiments included herein present a system and method to transmit the data using a wireless radio signal to achieve the goal of measuring sensing data from within the battery cell without altering or negatively impacting the hermetic seal of the cell. In some embodiments, the ability to measure and report internal cell pressure and temperature can be used to better improve the management of the cell and its state of health (SOH) to provide a longer useable battery life. As a safety feature, prismatic cells may be fitted with a pressure release valve, designed to ensure that the cell does not explode. Although embodiments included herein may not eliminate the requirement for a safety valve, the ability to measure the internal pressure, as well as other internal conditions, of a battery cell can help protect the cell and prevent thermal runaway, as controllers and/or the battery management system (BMS) can stop charging or discharging if a cell is showing abnormal pressure and temperature characteristics.

Referring now to FIG. 1, a diagram of a battery pack system 100 is provided consistent with embodiments of the present disclosure. System 100 includes a battery cell 110, a communications system 112, a central controller 114, a Battery Management System (BMS) 116, a module of battery cells 118, and a battery pack 120.

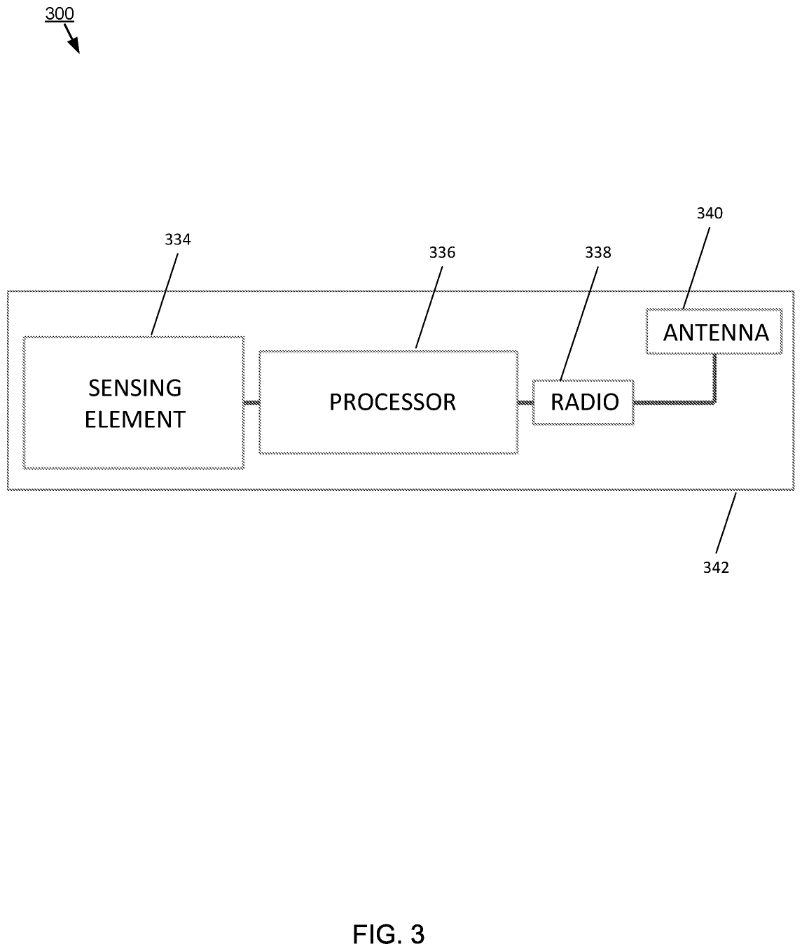

In some embodiments, each individual battery cell 110 includes a sensor assembly. The sensor assembly may include the sensor communication system 112 and a sensing element (not shown). The sensor assembly may be located within battery cell 110. In some embodiments, the sensor assembly may be hermetically sealed within battery cell 110. These embodiments, the entire portion of the sensor assembly, e.g. wires, power source, antenna, etc., may be located within the case of the battery cell. As such, sensor assembly may be powered by battery cell 110 it is monitoring. See, e.g., FIG. 3 for additional details of the sensor assembly.

In some embodiments, battery pack 120 contains the battery cell 110 and may contain other components of system 100. In some embodiments, battery pack 120 may contain a plurality of battery cells 110. The plurality of battery cells 110 may be configured into module of battery cells 118. In some embodiments, battery pack 120 may contain a plurality of modules of battery cells 118. Module of battery cells 118 may operate as a subsystem within battery pack 120.

In some embodiments, communication system 112 may enable wireless communication from battery cell 110 to central controller 114. Central controller 114 may be in direct communication with each individual battery cell 110. In some embodiments, central controller 114 may be in communication with modules of battery cells 118 as opposed to the individual battery cell 110. Central controller 114 may be configured to send and receive information to and from each communication system 112.

In some embodiments, in the scenario of an RF connection to an anode or cathode terminal, it should be noted that the local controller may adjust the output impedance of the radio module to optimize the efficiency of the generated RF signal strength. Depending on where the module is fitted inside battery pack 120, the corresponding RF impedance may change significantly and an automatic RF impedance adjustment would be relevant.

In some embodiments, system 100 may include a Battery Management System (BMS) 116. BMS 116 may be located in battery pack 120. Central controller 114 may relay sensing data acquired by the sensor assembly to BMS 116 by a wired or wireless signal. In some embodiments, BMS 116 may control the charging and discharging of the battery cells 110 and/or modules of battery cells 118 based upon, at least in part, the sensing data. In this way, BMS 116 may maintain a safe and/or optimal range of operation for individual battery cells 110.

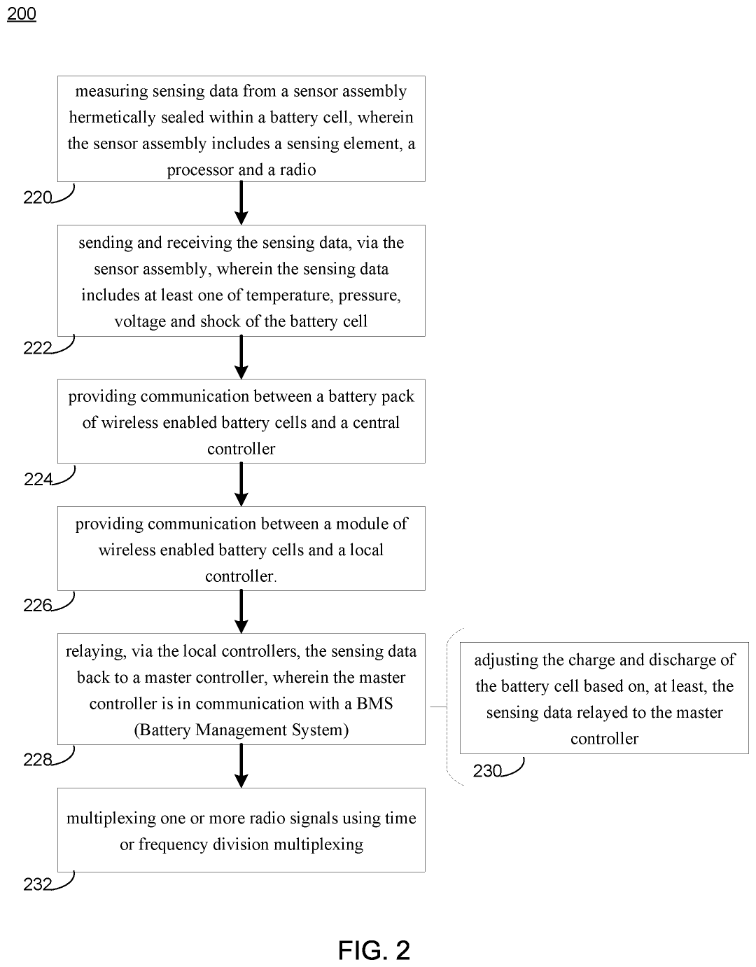

Referring now to FIG. 2, a flowchart 200 depicting a method of battery cell management is provided. The method may include measuring (220) sensing data from a sensor assembly hermetically sealed within a battery cell, wherein the sensor assembly includes a sensing element, a processor and a radio. The method may further include sending and receiving (222) the sensing data, via the sensor assembly, wherein the sensing data includes at least one of temperature, pressure, voltage and shock of the battery cell. The method may further include providing (224) communication between a battery pack of wireless enabled battery cells and a central controller. The method may also include providing (226) communication between a module of wireless enabled battery cells and a local controller. The method may further include relaying (228), via the local controllers, the sensing data back to a master controller, wherein the master controller is in communication with a BMS (Battery Management System). The method may also include adjusting (230) the charge and discharge of the battery cell based on, at least, the sensing data relayed to the master controller. The method may further include multiplexing (232) one or more radio signals, via the sensor assembly, using at least one of a time division multiplexing and a frequency division multiplexing. Numerous other operations are also within the scope of the present disclosure.

Referring now to FIG. 3, an embodiment of sensor assembly 300 is provided. Sensor assembly 300 may include a sensing element 334, a processor 336, a radio 338, and an antenna 340, contained within an enclosure 342. Processor 336, radio 338 and antenna 340 may operate as the communication system (e.g. communication system 112).

In some embodiments, sensing element 334 may measure one or more of temperature, pressure, voltage and physical shock of the battery cell (e.g. battery cell 110). Sensing element 334 may include one or more sensors, including but not limited to, resistance temperature detectors (RTDs), thermocouples, thermistors, strain gauges, MMS pressure sensors, MEMS pressure sensors, ceramic capacitive pressure sensors, resistive type voltage sensors, capacitive type voltage sensors, and/or accelerometers.

In some embodiments, processor 336 may be in communication with radio 338 and sensing element 334. Processor 336 may be configured to provide instructions to radio 338 and sensing element 334 for operation of sensor assembly 300. Processor 336 may include, or be substituted for, signal conditioning circuitry. In some embodiments, processor 336 may be included in a microcontroller within sensor assembly 300. Additionally and/or alternatively, processor 336 may have read and/or write access to memory. The memory may be configured to store sensing data and/or instructions for operation.

In some embodiments, radio 338 may be configured to send and receive sensing data from sensing element 334 via antenna 340. In some embodiments radio 338 may be in communication with local controllers, central controllers, master controllers, and/or receivers. Radio 338 may be configured to operate at one or more frequency bands, including, but not limited to, 433 MHz, 868 MHz, and 2.4 GHz. In some embodiments, radio 338 may be configured to multiplex one or more radio signals. Additionally and/or alternatively, processor 336, signal conditioning circuitry and/or a microcontroller may multiplex the radio signals and the radio may transmit the signal. Some multiplexing techniques may include, but are not limited to, a time division multiplexing and a frequency division multiplexing.

In some embodiments, antenna 340 may be suitably shaped and positioned to optimally transmit the signal from inside the battery cell. In some embodiments, antenna 340 may be connected to a case of the battery cell, wherein the case of the battery cell may operate as a part of the radiating element of antenna 340. In other embodiments, antenna 340 may be connected to an anode and/or a cathode of the battery cell, wherein the anode and/or the cathode may operate as a part of the radiating element of antenna 340. In this way, the battery cell case may help provide a better transmission without additional antenna material.

In some embodiments, enclosure 342 may be configured to contain and protect, all or part of, components of sensor assembly 300. Enclosure 342 may be configured to prevent the conditions within the battery cell from negatively affecting the components such as sensing element 334, processor 336, and radio 338 (e.g., preventing corrosion, etc.).

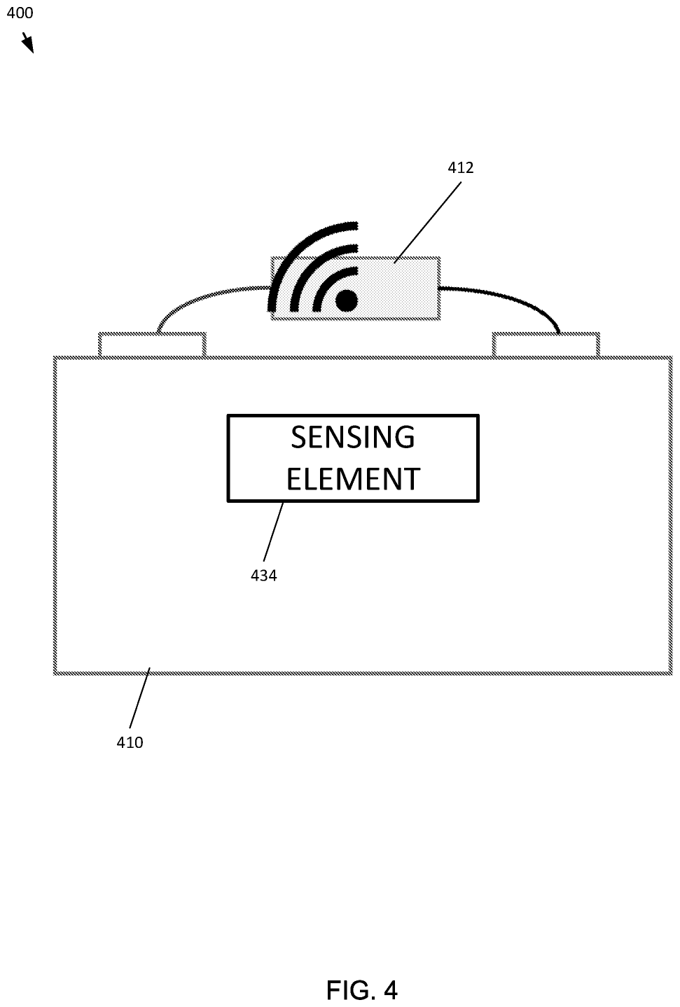

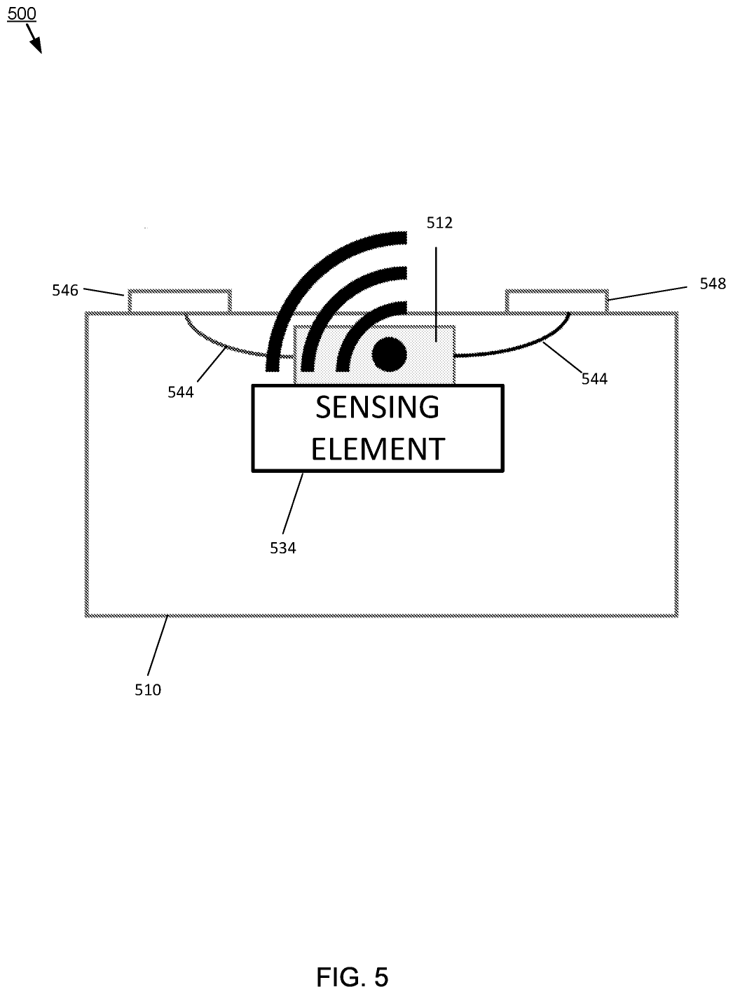

Referring now to FIG. 4, a diagram 400 of a battery cell is provided (e.g. a prismatic batter cell). If communications system 412 (e.g. processor 336, radio 338 and antenna 340) is external to the device then there may be an issue regarding how to measure sensing data from within battery cell 410 as sensing element 434 may still need to be in communication with communications system 412, without breaking the hermetic seal of battery cell 410. Accordingly, embodiments included herein may be configured so that the entire system within the cell maintains the hermetic seal as shown in FIG. 5.

Referring now to FIG. 5, a diagram 500 of a battery cell containing a sensor assembly consistent with embodiments of the present disclosure is provided. The sensor assembly may include sensing element 534 and communications system 512 (e.g., processor 336, radio 338 and antenna 340) both contained within battery cell 510 (e.g., a prismatic battery cell).

In some embodiments, the sensor assembly may be in electrical communication with battery cell 510. Specifically, the sensor assembly may receive power from the battery cell the sensor assembly is measuring. As shown in FIG. 5, communications system 512 may be connected via one or more wires 544 to anode 546 and cathode 548 of battery cell 510. In this way, communications system 512 and sensing element 534 may both receive power without introducing additional power sources into battery cell 510. Additionally and/or alternatively, communications system 512 and sensing element 534 may be hermetically sealed within battery cell 510 without having to transport power from a source external to battery cell 510.

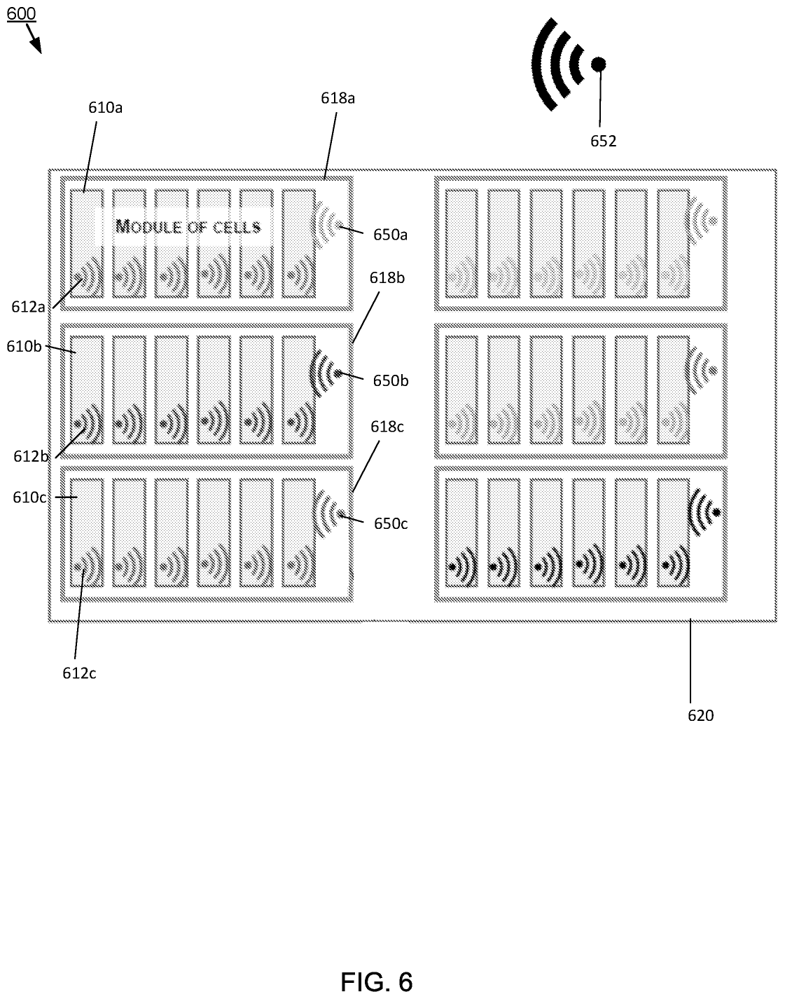

Referring now to FIG. 6, a diagram of battery pack system 600 consistent with embodiments of the present disclosure is provided. System 600 may include one or more modules of battery cells 618. Specifically in FIG. 6, modules of battery cells 618a, 618b, 618c are provided. Any number of modules of battery cells 618 are contemplated by embodiments of this disclosure.

In some embodiments, module of battery cells 618a may each include a plurality of battery cells 610a. Each battery cell 610a may include communication system 612a and a sensing element (not shown in FIG. 6, e.g. sensing element 434, 534). Likewise, module of battery cells 618b, 618c may also include a respective plurality of battery cells 610b, 610c, each having a respective communication system 612b, 612c.

In some embodiments, each module of battery cell 618a, 618b, 618c may communicate to the respective local controller 650a, 650b, 650c. For example, in some embodiments, local controller 650a may send and receive data from module of battery cell 618a. Local controller 650a, 650b, 650c may then relay the sensing data back to a master controller 652 which in turn communicates the sensing data with the BMS (e.g. BMS 116). The communication between local controller 650 and master controller 652 may be wired or wireless.

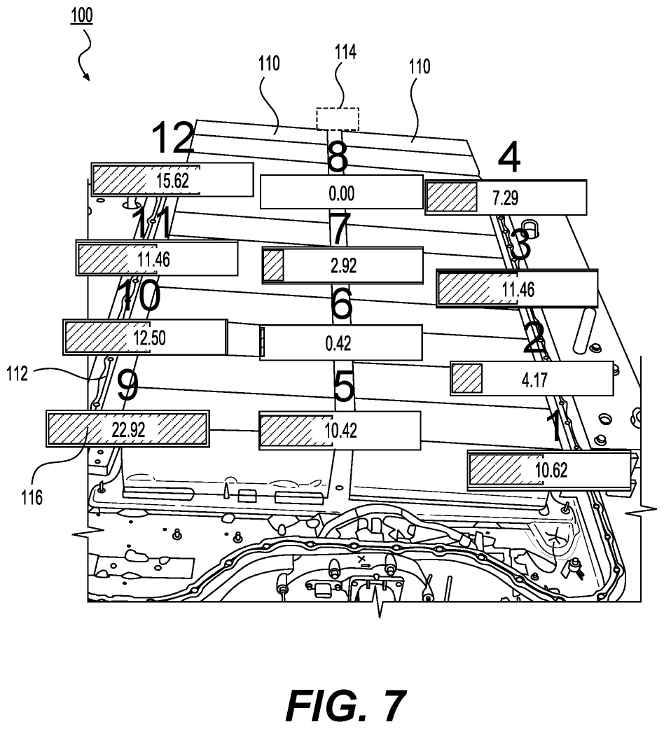

Referring now to FIG. 7, a diagram 700 illustrating an embodiment of the present disclosure is provided. In this example, an embodiment was successfully demonstrated and validated at 433 MHz within battery pack 720 consisting of a plurality of battery cells 110. In this particular example, Received Signal Strength Indicator (RSSI) data was recorded for a sensor assembly including a TPMS sensor (e.g., a HKMC faraday design) within an empty prismatic cell at different positions 754 in an automotive battery pack, specifically 12 different positions 754. Data was collected using a receiver 756 (e.g., a Sensata UTR with TDA5235 RF section) having a receiver sensitivity of approximately −105 dbm. Receiver 756 may be positioned at any suitable location, for example, on the inside of the battery case covering the battery cells 110. Receiver 756 may completely electrically separated from the battery power network in some implementations.

Numerical results are shown in FIG. 7 under positions 754 depicting RSSI margin db from within battery cell 710 to receiver 756 within battery pack 720 (e.g. an automotive battery pack). These results demonstrate that the system may operate at distances approaching 2 meters. Other embodiments may use one or more antennas designed to operate within the cell thereby enabling maximum signal transmission and increasing performance. For example, in some embodiments, an antenna may be connected to a case of the battery cell, wherein the case of the battery cell is configured to operate as a part of the radiating element of the antenna. In other embodiments, the antenna may be connected to an anode and/or a cathode, whereby the anode and/or cathode is configured to operate as a part of the radiating element of the antenna.

Other embodiments have been tested and shown as suitable at higher frequency bands to enable high data bandwidths. For example, 2.4 GHz bands have been tested and shown to establish communication between sensor assemblies in the battery cells and a receiver fitted in the battery pack.

Each of battery cells 710 in battery pack 720 shown in FIG. 7 is depicted as a metal cased prismatic battery cell, however, numerous other types of battery cells are also within the scope of the present disclosure. In some embodiments, battery cell 710 may be a prismatic can battery cell, a prismatic pouch battery cell, and a cylindrical can battery cell in addition to the metal cased prismatic battery cells in FIG. 7. In some embodiments, battery cells 710 may also include a rigid casing and/or flexible casing. The casing may also be called the enclosure or package of battery cell. Any suitable battery structure may be used without departing from the scope of the present disclosure.

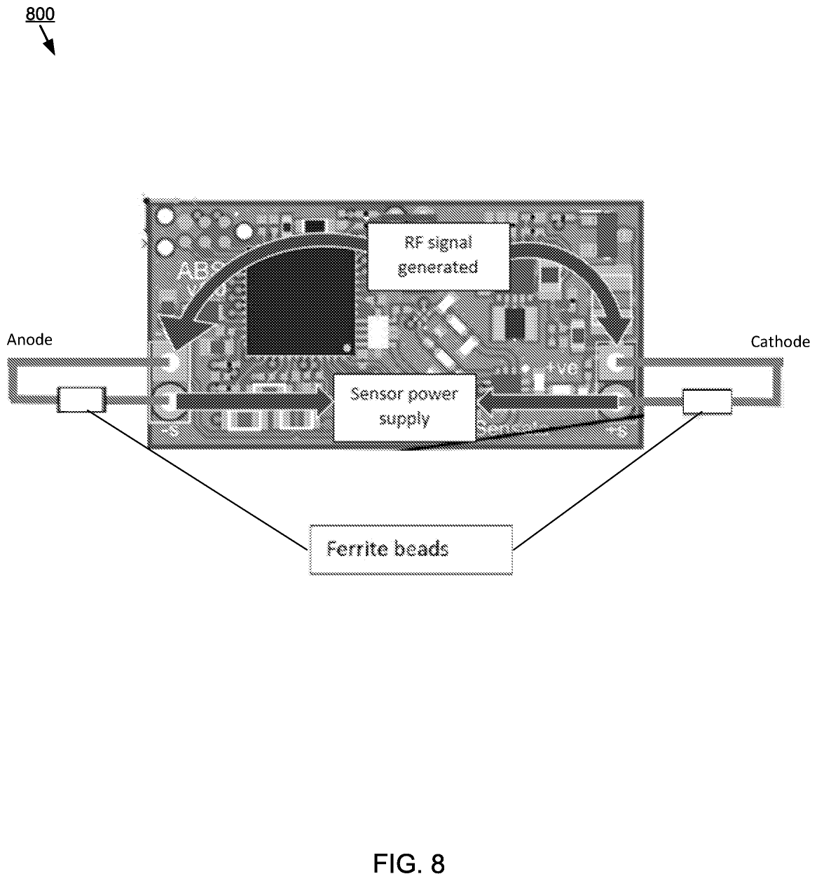

Referring now to FIG. 8, a diagram 800 illustrating an embodiment of the present disclosure is provided. In this example, the power supply of the sensor is shown decoupled from the RF signal using ferrite beads, although other materials may also be used without departing from the scope of the present disclosure. Here, the ferrite beads may present a high impedance for RF but may conduct direct current. The anode and cathode shown may be used as an RF antenna.

As used in any embodiment described herein, the term “circuitry” may comprise, for example, singly or in any combination, hardwired circuitry, programmable circuitry, state machine circuitry, and/or firmware that stores instructions executed by programmable circuitry. It should be understood at the outset that any of the operations and/or operative components described in any embodiment or embodiment herein may be implemented in software, firmware, hardwired circuitry and/or any combination thereof.

The terminology used herein is for the purpose of describing particular embodiments and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various embodiments with various modifications as are suited to the particular use contemplated.

Although a few example embodiments have been described in detail above, those skilled in the art will readily appreciate that many modifications are possible in the example embodiments without materially departing from the scope of the present disclosure, described herein. Accordingly, such modifications are intended to be included within the scope of this disclosure as defined in the following claims. In the claims, means-plus-function clauses are intended to cover the structures described herein as performing the recited function and not only structural equivalents, but also equivalent structures. Thus, although a nail and a screw may not be structural equivalents in that a nail employs a cylindrical surface to secure wooden parts together, whereas a screw employs a helical surface, in the environment of fastening wooden parts, a nail and a screw may be equivalent structures. It is the express intention of the applicant not to invoke 35 U.S.C. § 112, paragraph 6 for any limitations of any of the claims herein, except for those in which the claim expressly uses the words ‘means for’ together with an associated function.

Having thus described the disclosure of the present application in detail and by reference to embodiments thereof, it will be apparent that modifications and variations are possible without departing from the scope of the disclosure defined in the appended claims.

What is claimed is:

1. A method of in cell sensing comprising:
measuring sensing data from a sensor assembly hermetically sealed within a battery cell, wherein the sensor assembly includes a sensing element, a processor and a radio; and
sending and receiving the sensing data, via the sensor assembly, wherein the sensing data includes at least one of temperature, pressure, voltage and shock of the battery cell.

2. The method of claim 1, further comprising:
providing communication between a battery pack of wireless enabled battery cells and a central controller.

3. The method of claim 1, further comprising:
providing communication between a module of wireless enabled battery cells and a local controller.

4. The method of claim 3, further comprising:
relaying, via the local controllers, the sensing data back to a master controller, wherein the master controller is in communication with a BMS (Battery Management System).

5. The method of claim 4, wherein the communication between the local and master controllers is at least one of wired and wireless.

6. The method of claim 4, further comprising:
adjusting the charge and discharge of the battery cell based on, at least, the sensing data relayed to the master controller.

7. The method of claim 1, wherein the sensor assembly further includes an antenna connected to a case of the battery cell, whereby the case of the battery cell is configured to operate as a part of the radiating element of the antenna.

8. The method of claim 1, wherein the sensor assembly further includes an antenna connected to at least one of an anode and a cathode, whereby the at least one of the anode and the cathode is configured to operate as a part of the radiating element of the antenna.

9. The method of claim 1, wherein the sensor assembly further includes an antenna, wherein the radio is configured to operate at one or more frequency bands.

10. The method of claim 9, further comprising:
multiplexing one or more radio signals, via the sensor assembly, using at least one of a time division multiplexing and a frequency division multiplexing.

11. The method of claim 1, wherein the battery cell is at least one of a metal cased prismatic battery cell, a prismatic can battery cell, a prismatic pouch battery cell, and a cylindrical can battery cell.

12. The method of claim 1, wherein the battery cell includes at least one of a rigid casing and a flexible casing.

13. The method of claim 1, wherein the sensor assembly is in electrical communication with the battery cell.

14. A sensor assembly comprising:
a sensing element configured to measure sensing data within a battery cell, wherein the sensing data includes at least one of temperature, pressure, voltage and shock;
a processor in communication with the sensing element; and
a radio in communication with the processor and configured to send and receive sensing data, wherein the sensing element, the processor, and the radio are hermetically sealed within a battery cell.

15. The sensor assembly of claim 14, wherein the radio is configured to provide the sensing data to a local controller, the local controller configured to relay the sensing data to a master controller in communication with a BMS (Batter Management System).

16. The sensor assembly of claim 14, further comprising an antenna in communication with the radio, the antenna is connected to a case of the battery cell, whereby the case of the battery cell is configured to operate as a part of the radiating element of the antenna.

17. The sensor assembly of claim 14, further comprising an antenna in communication with the radio, the antenna is connected to at least one of an anode and a cathode, whereby the at least one of the anode and the cathode is configured to operate as a part of the radiating element of the antenna.

18. The sensor assembly of claim 14, wherein the radio is configured to operate at one or more frequency bands.

19. The sensor assembly of claim 14, wherein the radio is configured output a multiplexed signal of one or more radio signals, the multiplexed signal includes at least one of a time division multiplexing and a frequency division multiplexing.

20. The sensor assembly of claim 14, wherein the processor and the radio is in electrical communication with the battery cell.
